(19) United States
(12) Patent Application Publication
(10) Pub. No.: US 2009/0296826 A1
(43) Pub. Date: Dec. 3, 2009

(54) METHODS AND APPARATUS FOR VIDEO ERROR CORRECTION IN MULTI-VIEW CODED VIDEO

(75) Inventors: Purvin Bibhas Pandit, Franklin Park, NJ (US); Yeping Su, Camas, WA (US); Peng Yin, West Windsor, NJ (US)

Correspondence Address: Thomson Licensing LLC, P.O. Box 5312, Two Independence Way, PRINCETON, NJ, 08543-5312, US

(73) Assignee: Thomson Licensing

(21) Appl. No.: 12/448,739

(22) PCT Filed: Jan. 4, 2008
(86) PCT No.: PCT/US2008/000148

§ 371 Date: Jul. 2, 2009

Related U.S. Application Data
(60) Provisional application No. 60/883,458, filed on Jan. 4, 2007.

(51) Int. Cl. H04N 11/02

(52) U.S. Cl. 375/240.25; 375/E07.027

(57) ABSTRACT

There are provided methods and apparatus for video error correction in multi-view coded video. An apparatus includes a decoder for decoding pictures for at least one view corresponding to multi-view video content from a bitstream. The decoder determines whether any of the pictures corresponding to a particular one of the at least one view are lost using an existing syntax element. The existing syntax element is for performing another function other than picture loss determination. The particular one of the at least one view is compliant with at least one of a video coding standard and a video coding recommendation.

### CROSS-REFERENCE TO RELATED APPLICATIONS

This application claims the benefit of U.S. Provisional Application Ser. No. 60/883,458, filed Jan. 4, 2007, which is incorporated by reference herein in its entirety.

### TECHNICAL FIELD

The present principles relate generally to video decoding and, more particularly, to methods and apparatus for video error correction in multi-view coded video.

### BACKGROUND

When a picture is lost in a corrupted bitstream, several picture-based error concealment methods can be used to conceal the lost picture. In order to perform concealment, the loss of a picture and the location of the picture have to be determined.

There have been several methods to detect loss of picture in the single view case. In the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 recommendation (hereinafter the “MPEG-4 AVC standard”), the concept of frame_num serves the purpose of detecting loss of reference pictures. Additionally, Supplemental Enhancement Information (SEI) messages such as the recovery point SEI message, sub-sequence SEI message, recovery point SEI message, reference picture marking repetition SEI message, as well as the picture order count (POC) design, and the multiple reference picture buffering may be used for the purpose of picture loss detection.

However, such methods have not been extended for the multi-view case.

### SUMMARY

These and other drawbacks and disadvantages of the prior art are addressed by the present principles, which are directed to methods and apparatus for video error detection in multi-view coded video.

According to an aspect of the present principles, there is provided an apparatus. The apparatus includes a decoder for decoding pictures for at least one view corresponding to multi-view video content from a bitstream. The decoder determines whether any of the pictures corresponding to a particular one of the at least one view are lost using an existing syntax element. The existing syntax element is for performing another function other than picture loss determination. The particular one of the at least one view is compliant with at least one of a video coding standard and a video coding recommendation.

According to another aspect of the present principles, there is provided a method. The method includes decoding pictures for at least one view corresponding to multi-view video content from a bitstream. The decoding step includes determining whether any of the pictures corresponding to a particular one of the at least one view are lost using an existing syntax element. The existing syntax element is for performing another function other than picture loss determination.

According to yet another aspect of the present principles, there is provided an apparatus. The apparatus includes a decoder for decoding pictures for at least one view corresponding to multi-view video content from a bitstream. The pictures are representative of at least a portion of a video sequence. At least some of the pictures correspond to different time instances in the video sequence. The decoder determines whether all the pictures corresponding to a particular one of the different time instances are lost using an existing syntax element. The existing syntax element is for performing another function other than picture loss determination.

According to still another aspect of the present principles, there is provided a method. The method includes decoding pictures for at least one view corresponding to multi-view video content from a bitstream. The pictures are representative of at least a portion of a video sequence. At least some of the pictures correspond to different time instances in the video sequence. The decoding step includes determining whether all the pictures corresponding to a particular one of the different time instances are lost using an existing syntax element. The existing syntax element is for performing another function other than picture loss determination.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram for an exemplary Multi-view Video Coding (MVC) decoder to which the present principles may be applied, in accordance with an embodiment of the present principles;

FIG. 2 is a diagram for a time-first coding structure for a multi-view video coding system with 8 views to which the present principles may be applied, in accordance with an embodiment of the present principles;

FIG. 3 is a flow diagram for an exemplary method for decoding video data corresponding to a video sequence using error concealment for lost pictures, in accordance with an embodiment of the present principles;

FIG. 4 is a flow diagram for another exemplary method for decoding video data corresponding to a video sequence using error concealment for lost pictures, in accordance with an embodiment of the present principles;

FIG. 5 is a flow diagram for yet another exemplary method for decoding video data corresponding to a video sequence using error concealment, in accordance with an embodiment of the present principles; and

FIG. 6 is a flow diagram for still another exemplary method for decoding video data corresponding to a video sequence using error concealment, in accordance with an embodiment of the present principles.

### DETAILED DESCRIPTION

The present principles are directed to methods and apparatus for video error detection in multi-view coded video.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

As used herein, “high level syntax” refers to syntax present in the bitstream that resides hierarchically above the macroblock layer. For example, high level syntax, as used herein, may refer to, but is not limited to, syntax at the slice header level, the sequence parameter set (SPS) level, the picture parameter set (PPS) level, the view parameter set (VPS) level, the network abstraction layer (NAL) unit header level, and in a supplemental enhancement information (SEI) message.

For the sake of illustration and brevity, the following embodiments are described herein with respect to the use of the sequence parameter set. However, it is to be appreciated that the present principles are not limited to solely the use of the sequence parameter set with respect to the improved signaling disclosed herein and, thus, such improved signaling may be implemented with respect to at least the above-described types of high level syntaxes including, but not limited to, syntaxes at the slice header level, the sequence parameter set (SPS) level, the picture parameter set (PPS) level, the view parameter set (VPS) level, the network abstraction layer (NAL) unit header level, and in a supplemental enhancement information (SEI) message, while maintaining the spirit of the present principles.

It is to be further appreciated that while one or more embodiments of the present principles are described herein with respect to the MPEG-4 AVC standard, the present principles are not limited to solely this standard and, thus, may be utilized with respect to other video coding standards, recommendations, and extensions thereof, including extensions of the MPEG-4 AVC standard, while maintaining the spirit of the present principles.

Moreover, it is to be appreciated that the use of the term “and/or”, for example, in the case of “A and/or B”, is intended to encompass the selection of the first listed option (A), the selection of the second listed option (B), or the selection of both options (A and B). As a further example, in the case of “A, B, and/or C”, such phrasing is intended to encompass the selection of the first listed option (A), the selection of the second listed option (B), the selection of the third listed option (C), the selection of the first and the second listed options (A and B), the selection of the first and third listed options (A and C), the selection of the second and third listed options (B and C), or the selection of all three options (A and B and C). This may be extended, as readily apparent by one of ordinary skill in this and related arts, for as many items listed.

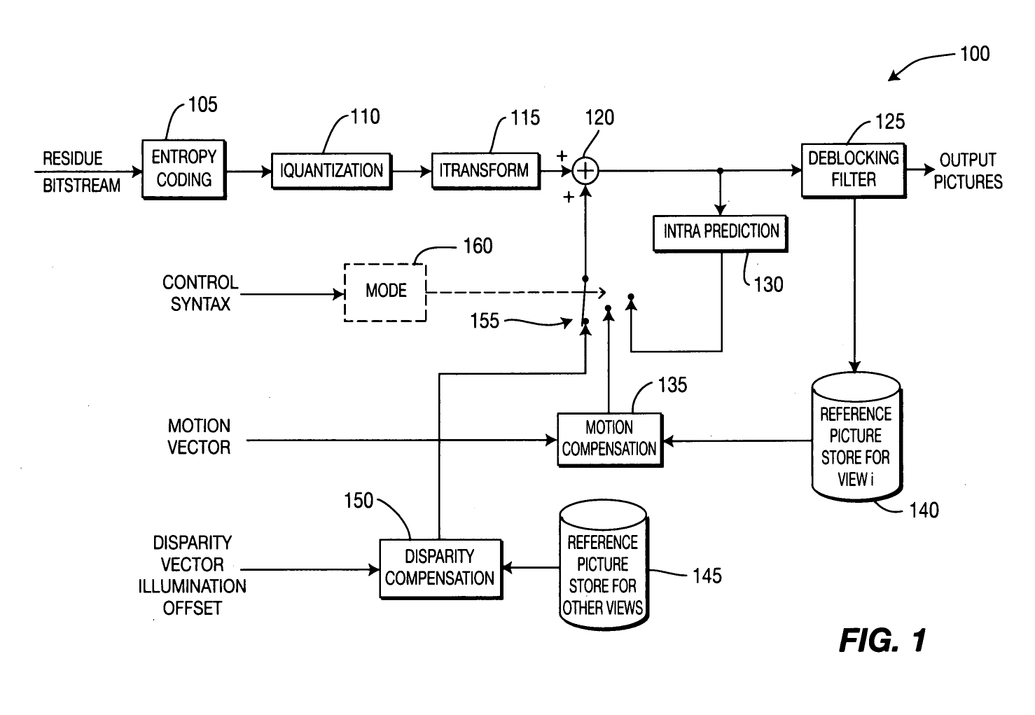

Turning to FIG. 1, an exemplary Multi-view Video Coding (MVC) decoder is indicated generally by the reference numeral 100. The decoder 100 includes an entropy decoder 105 having an output connected in signal communication with an input of an inverse quantizer 110. An output of the inverse quantizer is connected in signal communication with an input of an inverse transformer 115. An output of the inverse transformer 115 is connected in signal communication with a first non-inverting input of a combiner 120. An output of the combiner 120 is connected in signal communication with an input of a deblocking filter 125 and an input of an intra predictor 130. An output of the deblocking filter 125 is connected in signal communication with an input of a reference picture store 140 (for view i). An output of the reference picture store 140 is connected in signal communication with a first input of a motion compensator 135.

An output of a reference picture store 145 (for other views) is connected in signal communication with a first input of a disparity/illumination compensator 150.

An input of the entropy coder 105 is available as an input to the decoder 100, for receiving a residue bitstream. Moreover, an input of a mode module 160 is also available as an input to the decoder 100, for receiving control syntax to control which input is selected by the switch 155. Further, a second input of the motion compensator 135 is available as an input of the decoder 100, for receiving motion vectors. Also, a second input of the disparity/illumination compensator 150 is available as an input to the decoder 100, for receiving disparity vectors and illumination compensation syntax.

An output of a switch 155 is connected in signal communication with a second non-inverting input of the combiner 120. A first input of the switch 155 is connected in signal communication with an output of the disparity/illumination compensator 150. A second input of the switch 155 is connected in signal communication with an output of the motion compensator 135. A third input of the switch 155 is connected in signal communication with an output of the intra predictor 130. An output of the mode module 160 is connected in signal communication with the switch 155 for controlling which input is selected by the switch 155. An output of the deblocking filter 125 is available as an output of the decoder.

In accordance with the present principles, methods and apparatus are provided for video error concealment in multi-view coded video. The present principles, at the least, address the problem of picture loss in the case of multi-view coded video. Methods and apparatus are provided herein to detect when all pictures belonging to a certain time instance are lost.

In an error-prone transmission environment, such as the Internet, wireless networks, and so forth, a transmitted video bitstream may suffer corruptions caused by, for example, channel impairment. A common situation encountered in some practical systems is that certain compressed video pictures are dropped from a bitstream. This is especially true for low bit-rate applications where a picture is small enough to be coded into a transmit unit, such as a real-time transport protocol (RTP) packet. At the receiver end, a robust video decoder should be able to detect such losses in order to conceal them.

In multi-view video coding (MVC), there are several views present in the coded video sequence. In the case of the current MVC extension of the MPEG-4 AVC Standard, each picture has associated with it a view identifier to identify which view to which it belongs. TABLE 1 shows the Network Abstraction Layer (NAL) unit header for the scalable video coding (SVC) multi-view video coding (MVC) extension syntax. Additionally, there are several high level syntaxes (in addition to the MPEG-4 AVC Standard syntaxes) that are present to assist in the decoding of the pictures from different views. These syntaxes are present in the Sequence Parameter Set (SPS) extension. TABLE 2 shows the sequence parameter set (SPS) in the multi-view video coding (MVC) extension of the MPEG-4 AVC Standard.

TABLE 1

| | | |
|---|---|---|
| nal_unit_header_svc_mvc_extension( ) { | C | Descriptor |

| | | |
|---|---|---|
| svc_mvc_flag | All | u(1) |
| if (!svc_mvc_flag) { | | |

| | | |
|---|---|---|
| priority_id | All | u(6) |
| discardable_flag | All | u(1) |
| temporal_level | All | u(3) |
| dependency_id | All | u(3) |
| quality_level | All | u(2) |
| layer_base_flag | All | u(1) |
| use_base_prediction_flag | All | u(1) |
| fragmented_flag | All | u(1) |
| last_fragment_flag | All | u(1) |
| fragment_order | All | u(2) |
| reserved_zero_two_bits | All | u(2) |

} else {

| | | |
|---|---|---|
| temporal_level | All | u(3) |
| view_level | All | u(3) |
| anchor_pic_flag | All | u(1) |
| view_id | All | u(10) |
| idr_flag | All | u(1) |
| reserved_zero_five_bits | All | u(5) |

}
nalUnitHeaderBytes += 3

}

TABLE 2

| seq_parameter_set_mvc_extension( ) { | | C | Descriptor |
|---|---|---|---|
| | num_views_minus_1 | | ue(v) |
| | for(i = 0; i <= num_views_minus_1; i++) { | | |

| | |
|---|---|
| num_anchor_refs_I0[i] | ue(v) |
| for( j = 0; j < num_anchor_refs_I0[i]; j++ ) | |

| | |
|---|---|
| anchor_ref_I0[i][j] | ue(v) |

| | |
|---|---|
| num_anchor_refs_I1 [i] | ue(v) |
| for( j = 0; j < num_anchor_refs_I1[i]; j++ ) | |

| | |
|---|---|
| anchor_ref_I1[i][j] | ue(v) |

}
for(i = 0; i <= num_views_minus_1; i++) {

| | |
|---|---|
| num_non_anchor_refs_I0[i] | ue(v) |
| for( j = 0; j < num_non_anchor_refs_I0[i]; | |
| j++ ) | |

| | |
|---|---|
| non_anchor_ref_I0[i][j] | ue(v) |

| | |
|---|---|
| num_non_anchor_refs_I1[i] | ue(v) |
| for( j = 0; j < num_non_anchor_refs_I1[i]; | |
| j++ ) | |

| | |
|---|---|
| non_anchor_ref_I1[i](j] | ue(v) |

}

}

Thus, the current proposal for multi-view video coding based on the MPEG-4 AVC Standard (hereinafter “current MVC proposal for MPEG-4 AVC) includes high level syntax in the sequence parameter set (SPS) to indicate the number of coded views in the sequence. Additionally, the current MVC proposal for MPEG-4 AVC includes the inter-view references information for a view. The current MVC proposal for MPEG-4 AVC further distinguishes the dependencies of the anchor and non-anchor picture by separately sending the reference view identifiers. This is shown in TABLE 2, which includes information of which views are used as a reference for a certain view. We have recognized and propose that this information (the number of coded views) can be used in order to detect picture loss in the case of multi-view coded video.

In the current multi-view video coding (MVC) extension of the MPEG-4 AVC Standard, it is mandated that at least one view in the set of multiple views be compatible with the MPEG-4 AVC Standard. A picture belonging to view compatible with the MPEG-4 AVC Standard is identified by its network abstraction layer (NAL) unit type since MPEG-4 AVC Standard compatible pictures and pictures compatible with multi-view video coding use a different NAL unit type as shown in TABLE 3. Turning to TABLE 3, network abstraction layer (NAL) unit type codes are shown.

TABLE 3

| | Content of NAL unit and | |
|---|---|---|
| nal_unit_type | RBSP syntax structure | C |
| 0 | Unspecified | |
| 1 | Coded slice of a non-IDR picture | 2, 3, 4 |
| | slice_layer_without_partitioning_rbsp( ) | |
| 2 | Coded slice data partition A | 2 |
| | slice_data_partition_a_layer_rbsp( ) | |
| 3 | Coded slice data partition B | 3 |
| | slice_data_partition_b_layer_rbsp( ) | |
| 4 | Coded slice data partition C | 4 |
| | slice_data_partition_c_layer_rbsp( ) | |
| 5 | Coded slice of an IDR picture | 2, 3 |
| | slice_layer_without_partitioning_rbsp( ) | |
| 6 | Supplemental enhancement information (SEI) | 5 |
| | sei_rbsp( ) | |
| 7 | Sequence parameter set | 0 |
| | seq_parameter_set_rbsp( ) | |
| 8 | Picture parameter set | 1 |
| | pic_parameter_set_rbsp( ) | |
| 9 | Access unit delimiter | 6 |
| | access_unit_delimiter_rbsp( ) | |
| 10 | End of sequence | 7 |
| | end_of_seq_rbsp( ) | |
| 11 | End of stream | 8 |
| | end_of_stream_rbsp( ) | |
| 12 | Filler data | 9 |
| | filler_data_rbsp( ) | |
| 13 | Sequence parameter set extension | 10 |
| | seq_parameter_set_extension_rbsp( ) | |
| 14 . . . 18 | Reserved | |
| 19 | Coded slice of an auxiliary coded picture | 2, 3, 4 |
| | without partitioning | |
| | slice_layer_without_partitioning_rbsp( ) | |
| 20 | Coded slice of a non-IDR picture in scalable | 2, 3, 4 |
| | extension | |
| | slice_layer_in_svc_mvc_extension_rbsp( ) | |
| 21 | Coded slice of an IDR picture in scalable | 2, 3 |
| | extension | |
| | slice_layer_in_svc_mvc_extension_rbsp( ) | |
| 22 . . . 23 | Reserved | |
| 24 . . . 31 | Unspecified | |

Each slice belonging to a MPEG-4 AVC Standard compatible view is mandated to be followed by another NAL unit called the suffix NAL unit. This NAL unit has the following semantics:

suffix NAL unit: A NAL unit that immediately follows another NAL unit in decoding order and includes descriptive information of the preceding NAL unit, which is referred to as the associated NAL unit. A suffix NAL unit shall have nal_ref_idc equal to 20 or 21. When svc_mvc_flag is equal to 0, it shall have dependency_id and quality_level both equal to 0, and shall not include a coded slice. When svc_mvc_flag is equal to 1, it shall have view_level equal to 0, and shall not include a coded slice. A suffix NAL unit belongs to the same coded picture as the associated NAL unit.

In an embodiment, a prefix NAL unit may precede the first slice of the MPEG-4 AVC Standard compatible picture. A prefix NAL unit is identified by NAL unit type 14. All the remaining slices of the MPEG-4 AVC Standard compatible picture will be followed by a suffix NAL unit.

As noted from the definition, a suffix NAL unit is always present after the MPEG-4 AVC Standard compatible NAL unit type and will include its view_id information. Additionally a prefix NAL unit will be present only for the first slice of the MPEG-4 AVC Standard compatible NAL unit.

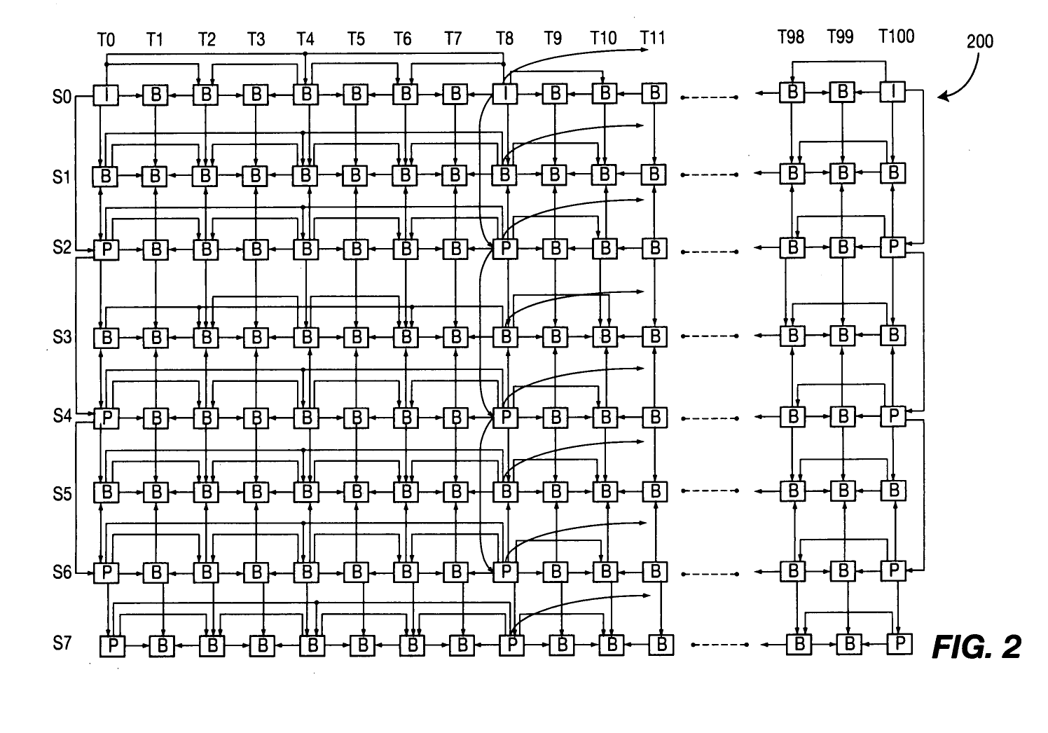

In the current multi-view coding extension of the MPEG-4 AVC Standard, it is mandated that pictures that belong to a certain time instant are coded first for all the views. Turning to FIG. 2, a time-first coding structure for a multi-view video coding system with 8 views is indicated generally by the reference numeral 200. In the example of FIG. 2, all pictures at the same time instance from different views are coded contiguously. Thus, all pictures (S0-S7) at time instant T0 are coded first, followed by pictures (S0-S7) at time T8, and so on. This is called time-first coding.

Also, in the current multi-view coding extension of the MPEG-4 AVC Standard, there is a constraint that inter-view prediction can only be done using pictures at that time instance. Further, there is also a requirement that at least one view is coded with MPEG-4 AVC Standard compatible syntax. Herein, this view is referred to as the base view. This view can be decoded independently i.e., without using any inter-view reference prediction. Also, this view will form the basis for an inter-view reference for all other views and, thus, will most likely be coded as the first picture of a time instance. Thus, timely concealment of the picture is desirable for the objective quality of other views. S0 in FIG. 2 is an example of a MPEG-4 AVC Standard compatible view.

To determine whether the pictures from all the views at a given time instance have been received and decoded, the following is to be considered: time-first coding; first coded picture at a time instance is a MPEG-4 AVC Standard compatible picture; and from the number of coded views in the sequence.

Thus, we can determine that the decoding of a different time instance is to occur when the following is applicable: the pictures from all the views at a given time instance have been received and decoded; or we receive a picture which is compatible with the MPEG-4 AVC Standard; or we receive a suffix or prefix NAL unit.

Accordingly, with the preceding information, we can determine if a picture that is compatible with the MPEG-4 AVC Standard is lost in at least two illustrative ways described herein. Of course, given the teachings of the present principles provided herein, one of ordinary skill in this and related arts will contemplate these and various other ways to determine whether a picture that is compatible with the MPEG-4 AVC Standard is lost, while maintaining the spirit of the present principles.

An illustrative embodiment will now be described regarding the determining whether a picture compatible with the MPEG-4 AVC Standard is lost. Regarding the embodiment, after the decoder has received and decoded the pictures from all the views at a given time instance, the decoder expects to receive a picture from a different time instance. The first picture the decoder expects to receive is a picture compatible with the MPEG-4 AVC Standard. The decoder can then check to see if this picture is indeed a MPEG-4 AVC Standard compatible picture by looking at the NAL unit type of the picture. If the NAL unit type is not a MPEG-4 AVC Standard compatible NAL unit, then it can be concluded that a picture was not received compatible with the MPEG-4 AVC Standard. If the picture was, in fact, compatible with the MPEG-4 AVC Standard, then an appropriate concealment algorithm/process can be called to conceal the picture.

In another illustrative embodiment, we can detect lost pictures compatible with the MPEG-4 AVC Standard if we receive only the suffix or prefix NAL unit. A suffix NAL unit is associated with every MPEG-4 AVC Standard compatible NAL unit and is present immediately after the MPEG-4 AVC Standard compatible NAL unit. A prefix NAL unit is present only for the first slice of the MPEG-4 AVC Standard compatible picture. If we only receive a suffix or prefix NAL unit, then it can be known that the MPEG-4 AVC Standard compatible NAL unit is lost.

It is possible that in a highly lossy environment all the pictures for a certain time instance are lost. It is desirable that such a loss be detected so that appropriate concealment can be performed.

As noted above, FIG. 2 shows an example of multi-view coding. In FIG. 2, hierarchical B pictures are used in the temporal domain. There are different coding orders that can be followed to code hierarchical B pictures. One is the low delay mode where the coding order would be T0, T8, T4, T2, T1, T3, T6, T5, and T7. Another way can be called layer first coding where the pictures are coded by the temporal levels. The temporal level of a picture is indicated in the NAL unit header as shown in Table 1. For this case, the coding order would be T0, T8, T4, T2, T6, T1, T3, T5, and T7. In either case, the anchor pictures may have a temporal level of 0.

For applications that use layer first coding, we determine whether all the pictures for a give time instance are lost.

In the example of FIG. 2, there are four temporal layers as follows: 0; 1; 2; and 3. The four layers relate to the following pictures as follows:

Picture T0, T8—temporal level 0

Picture T4—temporal level 1

Picture T2, T6—temporal level 2

Picture T5, T5—temporal level 3

Thus, the temporal coding order for layer first coding is 0, 1, 2, 3, 0, 1, 2, 3, and so on. This means that the temporal layer increases up to the highest temporal level and then decreases back to 0 (temporal level of the anchor pictures). In consideration of this, if all the pictures with temporal level 0 at a certain time instance are lost then the we will get the following order of temporal levels, 0, 1, 2, 3, 1, 2, 3, 0, 1, 2, 3, and so on.

Accordingly, after the highest temporal level, the temporal level decreased but was not 0. This condition is an indication that temporal level 0 was missing and, thus, the pictures associated with temporal level 0 are lost.

This method cannot only be used to detect the loss of pictures with temporal level 0 but also the loss of any other temporal level. Since we are presuming layer first coding, all the layers are received in an increasing order as described in the above example. The decoder can keep track of this order and detect a missing temporal level (by detecting a gap between the received temporal level and the expected temporal level).

For example, if there are 4 temporal levels coded as 0, 1, 2, 3, 0, 1, 2, 3 and so on, and if we receive 0, 1, 2, 3, 0, 1, 2, 3, 0, 1, 3, 0, 2, 3, then by keeping an internal counter we can determine that temporal level 2 was lost in group of pictures (GOP) 3 and temporal level 1 was lost in GOP 4. An appropriate error concealment algorithm/process can then be invoked to conceal the lost pictures.

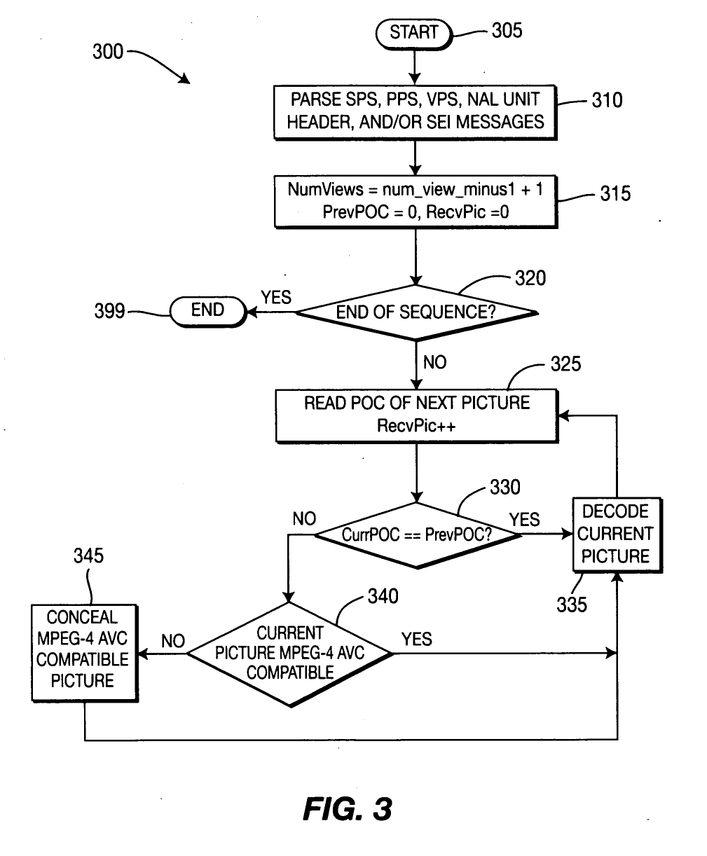

Turning to FIG. 3, an exemplary method for decoding video data corresponding to a video sequence using error concealment for lost pictures is indicated generally by the reference numeral 300.

The method 300 includes a start block 305 that passes control to a function block 310. The function block 310 parses the sequence parameter set (SPS), the picture parameter set (PPS), the view parameter set (VPS), network abstraction layer (NAL) unit headers, and/or supplemental enhancement information (SEI) messages, and passes control to a function block 315. The function block 315 sets a variable NumViews equal to a variable num_view_minus1+1, sets a variable PrevPOC equal to zero, sets a variable RecvPic equal to zero, and passes control to a decision block 320. The decision block 320 determines whether or not the end of the video sequence has been reached. If so, then control is passed to an end block 399. Otherwise, control is passed to a function block 325.

The function block 325 reads the picture order count (POC) of the next picture, increments the variable RcvPic, and passes control to a decision block 330. The decision block 330 determines whether or not the variable CurrPOC is equal to the variable PrevPOC. If so, then control is passed to a function block 335. Otherwise, control is passed to a decision block 340.

The function block 335 decodes the current picture, and returns control to the function block 325.

The decision block 340 determines whether or not the current picture is compatible with the MPEG-4 AVC Standard. If so, then control is returned to the function block 335. Otherwise, control is passed to a function block 345.

The function block 345 conceals the MPEG-4 AVC compatible picture, and returns control to the function block 335.

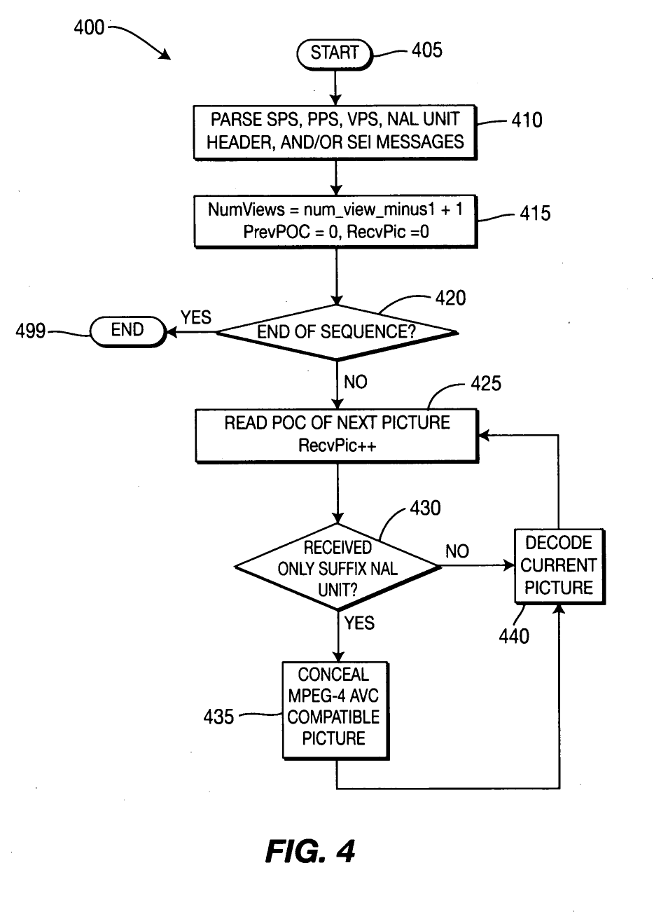

Turning to FIG. 4, another exemplary method for decoding video data corresponding to a video sequence using error concealment for lost pictures is indicated generally by the reference numeral 400.

The method 400 includes a start block 405 that passes control to a function block 410. The function block 410 parses the sequence parameter set (SPS), the picture parameter set (PPS), the view parameter set (VPS), network abstraction layer (NAL) unit headers, and/or supplemental enhancement information (SEI) messages, and passes control to a function block 415. The function block 415 sets a variable NumViews equal to a variable num_view_minus1+1, sets a variable PrevPOC equal to zero, sets a variable RecvPic equal to zero, and passes control to a decision block 420. The decision block 420 determines whether or not the end of the video sequence has been reached. If so, then control is passed to an end block 499. Otherwise, control is passed to a function block 425.

The function block 425 reads the picture order count (POC) of the next picture, increments the variable RcvPic, and passes control to a decision block 430. The decision block 430 determines whether or not only a suffix NAL unit was received. If so, then control is passed to a function block 435. Otherwise, control is passed to a function block 440.

The function block 435 conceals the MPEG-4 AVC compatible picture, and passes control to the function block 440.

The function block 440 decodes the current picture, and returns control to the function block 435.

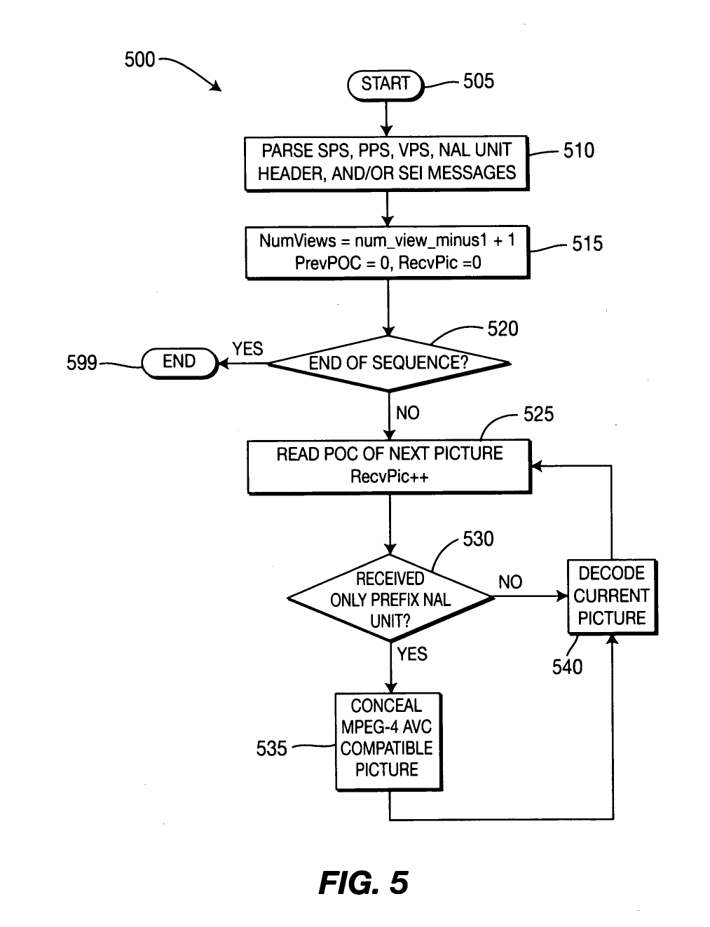

Turning to FIG. 5, yet another exemplary method for decoding video data corresponding to a video sequence using error concealment is indicated generally by the reference numeral 500.

The method 500 includes a start block 505 that passes control to a function block 510. The function block 510 parses the sequence parameter set (SPS), the picture parameter set (PPS), the view parameter set (VPS), network abstraction layer (NAL) unit headers, and/or supplemental enhancement information (SEI) messages, and passes control to a function block 515. The function block 515 sets a variable NumViews equal to a variable num_view_minus1+1, sets a variable PrevPOC equal to zero, sets a variable RecvPic equal to zero, and passes control to a decision block 520. The decision block 520 determines whether or not the end of the video sequence has been reached. If so, then control is passed to an end block 599. Otherwise, control is passed to a function block 525.

The function block 525 reads the picture order count (POC) of the next picture, increments the variable RcvPic, and passes control to a decision block 530. The decision block 530 determines whether or not only a prefix NAL unit was received. If so, then control is passed to a function block 535. Otherwise, control is passed to a function block 540.

The function block 535 conceals the MPEG-4 AVC compatible picture, and passes control to the function block 540.

The function block 540 decodes the current picture, and returns control to the function block 535.

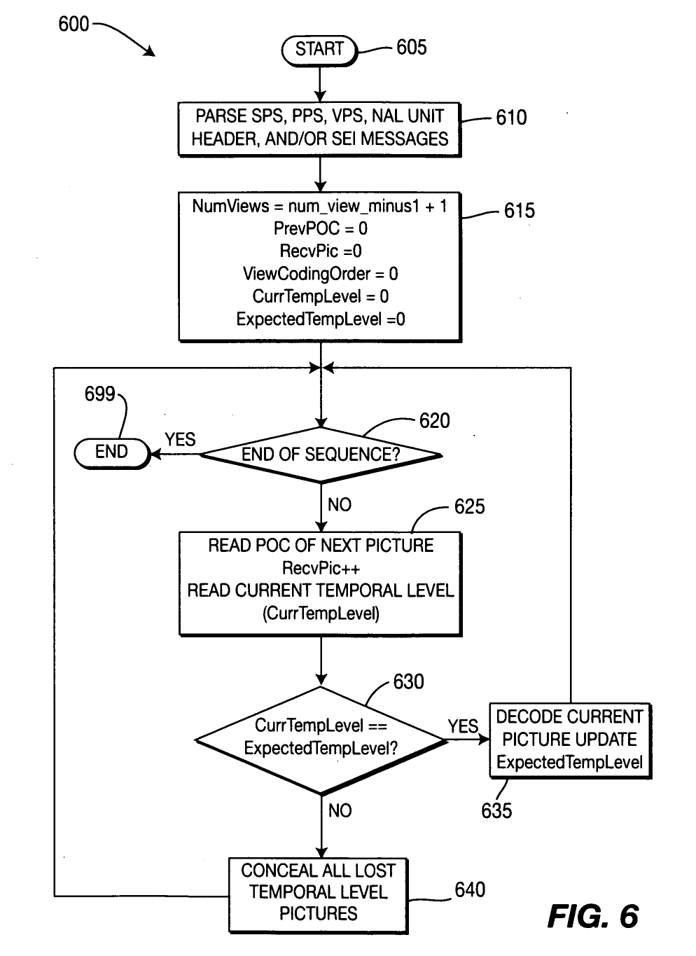

Turning to FIG. 6, still another exemplary method for decoding video data corresponding to a video sequence using error concealment is indicated generally by the reference numeral 600.

The method 600 includes a start block 605 that passes control to a function block 610. The function block 610 parses the sequence parameter set (SPS), the picture parameter set (PPS), the view parameter set (VPS), network abstraction layer (NAL) unit headers, and/or supplemental enhancement information (SEI) messages, and passes control to a function block 615. The function block 615 sets a variable NumViews equal to a variable num_view_minus1+1, sets a variable PrevPOC equal to zero, sets a variable RecvPic equal to zero, sets a variable ViewCodingOrder equal to zero, sets a variable CurrTempLevel equal to zero, sets a variable ExpectedTempLevel equal to zero, and passes control to a decision block 620. The decision block 620 determines whether or not the end of the video sequence has been reached. If so, then control is passed to an end block 699. Otherwise, control is passed to a function block 625.

The function block 625 reads the picture order count (POC) of the next picture, increments the variable RcvPic, reads the current temporal level (i.e., by reading the variable CurrTempLevel), and passes control to a decision block 630. The decision block 630 determines whether or not the variable CurrTempLevel is equal to the variable ExpectedTempLevel. If so, then control is passed to a function block 635. Otherwise, control is passed to a function block 640.

The function block 635 decodes the current picture, updates the variable ExpectedTempLevel, and returns control to the decision block 620.

The function block 640 conceals all lost temporal level pictures, and returns control to the decision block 620.

A description will now be given of some of the many attendant advantages/features of the present invention, some of which have been mentioned above. For example, one advantage/feature is an apparatus that includes a decoder for decoding pictures for at least one view corresponding to multi-view video content from a bitstream. The decoder determines whether any of the pictures corresponding to a particular one of the at least one view are lost using an existing syntax element. The existing syntax element is for performing another function other than picture loss determination. The particular one of the at least one view is compliant with at least one of a video coding standard and a video coding recommendation.

Another advantage/feature is the apparatus having the decoder as described above, wherein the existing syntax element is a multi-view video coding syntax element.

Yet another advantage/feature is the apparatus having the decoder wherein the existing syntax element is a multi-view video coding syntax element as described above, wherein the multi-view video coding syntax element corresponds to an extension of the International Organization for Standardization/International Electrotechnical Commission Moving Picture Experts Group-4 Part 10 Advanced Video Coding standard/International Telecommunication Union, Telecommunication Sector H.264 recommendation.

Still another advantage/feature is the apparatus having the decoder as described above, wherein the at least one of the video coding standard and the video coding recommendation correspond to the International Organization for Standardization/International Electrotechnical Commission Moving Picture Experts Group-4 Part 10 Advanced Video Coding standard/International Telecommunication Union, Telecommunication Sector H.264 recommendation.

Moreover, another advantage/feature is the apparatus having the decoder as described above, wherein the existing syntax element is present at a high level.

Further, another advantage/feature is the apparatus having the decoder as described above, wherein the high level corresponds to at least at one of a slice header level, a sequence parameter set level, a picture parameter set level, a view parameter set level, a network abstraction layer unit header level, and a level corresponding to a supplemental enhancement information message.

Also, another advantage/feature is the apparatus having the decoder as described above, wherein the other function of the existing syntax element is for indicating a number of coded views in the bitstream, including the at least one view.

Additionally, another advantage/feature is the apparatus having the decoder as described above, wherein the any of the pictures comprise at least one particular picture compatible with the International Organization for Standardization/international Electrotechnical Commission Moving Picture Experts Group-4 Part 10 Advanced Video Coding standard/International Telecommunication Union, Telecommunication Sector H.264 recommendation, and the decoder determines whether the at least one particular picture is lost based on time first coding information.

Moreover, another advantage/feature is the apparatus having the decoder as described above, wherein the pictures are representative of at least a portion of a video sequence, at least some of the pictures corresponding to different time instances in the video sequence, the any of the pictures comprising at least one particular picture compatible with the International Organization for Standardization/International Electrotechnical Commission Moving Picture Experts Group-4 Part 10 Advanced Video Coding standard/International Telecommunication Union, Telecommunication Sector H.264 recommendation, and the decoder determines whether the at least one particular picture is lost based on a number of the pictures corresponding to the particular one of the at least one view received at a particular one of the different time instances and a first one of the pictures corresponding to the particular one of the at least one view received at another particular one of the different time instances.

Further, another advantage/feature is the apparatus having the decoder that determines whether the at least one particular picture is lost based on a number of the pictures corresponding to the particular one of the at least one view received at a particular one of the different time instances and a first one of the pictures corresponding to the particular one of the at least one view received at another particular one of the different time instances, wherein the first one of the pictures received at the other particular one of the different time instances is not compatible with the International Organization for Standardization/International Electrotechnical Commission Moving Picture Experts Group-4 Part 10 Advanced Video Coding standard/International Telecommunication Union, Telecommunication Sector H.264 recommendation.

Also, another advantage/feature is the apparatus having the decoder as described above, wherein the decoder indicates at least one of the pictures corresponding to the particular one of the at least one view is lost when only a suffix network abstraction layer unit corresponding to the at least one of the pictures is received, the at least one of the pictures being compatible with the International Organization for Standardization/International Electrotechnical Commission Moving Picture Experts Group-4 Part 10 Advanced Video Coding standard/International Telecommunication Union, Telecommunication Sector H.264 recommendation.

Additionally, another advantage/feature is the apparatus having the decoder as described above, wherein the decoder indicates at least one of the pictures corresponding to the particular one of the at least one view is lost when only a prefix network abstraction layer unit corresponding to the at least one of the pictures is received, the at least one of the pictures being compatible with the International Organization for Standardization/International Electrotechnical Commission Moving Picture Experts Group-4 Part 10 Advanced Video Coding standard/International Telecommunication Union, Telecommunication Sector H.264 recommendation.

Moreover, another advantage/feature is an apparatus that includes a decoder for decoding pictures for at least one view corresponding to multi-view video content from a bitstream. The pictures are representative of at least a portion of a video sequence. At least some of the pictures correspond to different time instances in the video sequence. The decoder determines whether all the pictures corresponding to a particular one of the different time instances are lost using an existing syntax element. The existing syntax element is for performing another function other than picture loss determination.

Another advantage/feature is the apparatus having the decoder as described above, wherein the existing syntax element is a multi-view video coding syntax element.

Yet another advantage/feature is the apparatus having the decoder wherein the existing syntax element is a multi-view video coding syntax element as described above, wherein the multi-view video coding syntax element corresponds to an extension of the International Organization for Standardization/International Electrotechnical Commission Moving Picture Experts Group-4 Part 10 Advanced Video Coding standard/international Telecommunication Union, Telecommunication Sector H.264 recommendation.

Still another advantage/feature is the apparatus having the decoder as described above, wherein the existing syntax element is present at a high level.

Moreover, another advantage/feature is the apparatus having the decoder as described above, wherein the high level corresponds to at least at one of a slice header level, a sequence parameter set level, a picture parameter set level, a view parameter set level, a network abstraction layer unit header level, and a level corresponding to a supplemental enhancement information message.

Further, another advantage/feature is the apparatus having the decoder as described above, wherein the other function of the existing syntax element is for indicating a temporal level.

Also, another advantage/feature is the apparatus having the decoder wherein the other function of the existing syntax element is for indicating a temporal level as described above, wherein the pictures corresponding to the particular one of the different time instances include anchor pictures and non-anchor pictures, and the decoder ascertains whether all the anchor pictures corresponding to the particular one of the different time instances are lost using the temporal level, wherein the temporal level used is a first temporal level.

Additionally, another advantage/feature is the apparatus having the decoder that ascertains whether all the anchor pictures corresponding to the particular one of the different time instances are lost using the temporal level, wherein the temporal level used is a first temporal level, as described above, wherein the decoder uses a drop in the temporal level from a highest temporal level in the bitstream to a non-zero temporal level, the drop being at least two or more integer values, to detect the loss of all the anchor pictures with the first temporal level equal to zero and corresponding to the particular one of the different time instances.

Moreover, another advantage/feature is the apparatus having the decoder that ascertains whether all the anchor pictures corresponding to the particular one of the different time instances are lost using the temporal level, wherein the temporal level used is a first temporal level, as described above, wherein the decoder determines whether all the non-anchor pictures belonging to a missing temporal level and corresponding to the particular one of the different time instances are lost, based on an absence of the missing temporal level.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
a decoder for decoding pictures for at least one view corresponding to multi-view video content from a bitstream, wherein said decoder determines whether any of the pictures corresponding to a particular one of the at least one view are lost using an existing syntax element, the existing syntax element for performing another function other than picture loss determination, the particular one of the at least one view being compliant with at least one of a video coding standard and a video coding recommendation.

2. The apparatus of claim 1, wherein the existing syntax element is a multi-view video coding syntax element.

3. The apparatus of claim 2, wherein the multi-view video coding syntax element corresponds to an extension of the International Organization for Standardization/International Electrotechnical Commission Moving Picture Experts Group-4 Part 10 Advanced Video Coding standard/International Telecommunication Union, Telecommunication Sector H.264 recommendation.

4. The apparatus of claim 1, wherein the at least one of the video coding standard and the video coding recommendation correspond to the International Organization for Standardization/International Electrotechnical Commission Moving Picture Experts Group-4 Part 10 Advanced Video Coding standard/International Telecommunication Union, Telecommunication Sector H.264 recommendation.

5. The apparatus of claim 1, wherein the existing syntax element is present at a high level.

6. The apparatus of claim 1, wherein the high level corresponds to at least at one of a slice header level, a sequence parameter set level, a picture parameter set level, a view parameter set level, a network abstraction layer unit header level, and a level corresponding to a supplemental enhancement information message.

7. The apparatus of claim 1, wherein the other function of the existing syntax element is for indicating a number of coded views in the bitstream, including the at least one view.

8. The apparatus of claim 1, wherein the any of the pictures comprise at least one particular picture compatible with the International Organization for Standardization/International Electrotechnical Commission Moving Picture Experts Group-4 Part 10 Advanced Video Coding standard/International Telecommunication Union, Telecommunication Sector H.264 recommendation, and said decoder determines whether the at least one particular picture is lost based on time first coding information.

9. The apparatus of claim 1, wherein the pictures are representative of at least a portion of a video sequence, at least some of the pictures corresponding to different time instances in the video sequence, the any of the pictures comprising at least one particular picture compatible with the International Organization for Standardization/International Electrotechnical Commission Moving Picture Experts Group-4 Part 10 Advanced Video Coding standard/International Telecommunication Union, Telecommunication Sector H.264 recommendation, and said decoder determines whether the at least one particular picture is lost based on a number of the pictures corresponding to the particular one of the at least one view received at a particular one of the different time instances and a first one of the pictures corresponding to the particular one of the at least one view received at another particular one of the different time instances.

10. The apparatus of claim 9, wherein the first one of the pictures received at the other particular one of the different time instances is not compatible with the International Organization for Standardization/International Electrotechnical Commission Moving Picture Experts Group-4 Part 10 Advanced Video Coding standard/International Telecommunication Union, Telecommunication Sector H.264 recommendation.

11. The apparatus of claim 1, wherein said decoder indicates at least one of the pictures corresponding to the particular one of the at least one view is lost when only a suffix network abstraction layer unit corresponding to the at least one of the pictures is received, the at least one of the pictures being compatible with the International Organization for Standardization/International Electrotechnical Commission Moving Picture Experts Group-4 Part 10 Advanced Video Coding standard/International Telecommunication Union, Telecommunication Sector H.264 recommendation.

12. The apparatus of claim 1, wherein said decoder indicates at least one of the pictures corresponding to the particular one of the at least one view is lost when only a prefix network abstraction layer unit corresponding to the at least one of the pictures is received, the at least one of the pictures being compatible with the International Organization for Standardization/International Electrotechnical Commission Moving Picture Experts Group-4 Part 10 Advanced Video Coding standard/International Telecommunication Union, Telecommunication Sector H.264 recommendation.

13. A method, comprising:
decoding pictures for at least one view corresponding to multi-view video content from a bitstream, wherein said decoding step comprises determining whether any of the pictures corresponding to a particular one of the at least one view are lost using an existing syntax element, the existing syntax element for performing another function other than picture loss determination.

14. The method of claim 13, wherein the existing syntax element is a multi-view video coding syntax element.

15. The method of claim 14, wherein the multi-view video coding syntax element corresponds to an extension of the International Organization for Standardization/International Electrotechnical Commission Moving Picture Experts Group-4 Part 10 Advanced Video Coding standard/International Telecommunication Union, Telecommunication Sector H.264 recommendation.

16. The method of claim 13, wherein the at least one of the video coding standard and the video coding recommendation correspond to the International Organization for Standardization/International Electrotechnical Commission Moving Picture Experts Group-4 Part 10 Advanced Video Coding standard/International Telecommunication Union, Telecommunication Sector H.264 recommendation.

17. The method of claim 13, wherein the existing syntax element is present at a high level.

18. The method of claim 13, wherein the high level corresponds to at least at one of a slice header level, a sequence parameter set level, a picture parameter set level, a view parameter set level, a network abstraction layer unit header level, and a level corresponding to a supplemental enhancement information message.

19. The method of claim 13, wherein the other function of the existing syntax element is for indicating a number of coded views in the bitstream, including the at least one view.

20. The method of claim 13, wherein the any of the pictures comprise at least one particular picture compatible with the International Organization for Standardization/International Electrotechnical Commission Moving Picture Experts Group-4 Part 10 Advanced Video Coding standard/International Telecommunication Union, Telecommunication Sector H.264 recommendation, and said determining step comprises determining whether the at least one particular picture is lost based on time first coding information.

21. The method of claim 13, wherein the pictures are representative of at least a portion of a video sequence, at least some of the pictures corresponding to different time instances in the video sequence, the any of the pictures comprising at least one particular picture compatible with the International Organization for Standardization/International Electrotechnical Commission Moving Picture Experts Group-4 Part 10 Advanced Video Coding standard/International Telecommunication Union, Telecommunication Sector H.264 recommendation, and said determining step comprises determining whether the at least one particular picture is lost based on a number of the pictures corresponding to the particular one of the at least one view received at a particular one of the different time instances and a first one of the pictures corresponding to the particular one of the at least one view received at another particular one of the different time instances.

22. The method of claim 21, wherein the first one of the pictures received at the other particular one of the different time instances is not compatible with the International Organization for Standardization/International Electrotechnical Commission Moving Picture Experts Group-4 Part 10 Advanced Video Coding standard/International Telecommunication Union, Telecommunication Sector H.264 recommendation.

23. The method of claim 13, wherein said decoding step comprises indicating at least one of the pictures corresponding to the particular one of the at least one view is lost when only a suffix network abstraction layer unit corresponding to the at least one of the pictures is received, the at least one of the pictures being compatible with the International Organization for Standardization/International Electrotechnical Commission Moving Picture Experts Group-4 Part 10 Advanced Video Coding standard/International Telecommunication Union, Telecommunication Sector H.264 recommendation.

24. The method of claim 13, wherein said decoding step comprises indicating at least one of the pictures corresponding to the particular one of the at least one view is lost when only a prefix network abstraction layer unit corresponding to the at least one of the pictures is received, the at least one of the pictures being compatible with the International Organization for Standardization/International Electrotechnical Commission Moving Picture Experts Group-4 Part 10 Advanced Video Coding standard/International Telecommunication Union, Telecommunication Sector H.264 recommendation.

25. An apparatus, comprising:
a decoder for decoding pictures for at least one view corresponding to multi-view video content from a bitstream, the pictures representative of at least a portion of a video sequence, at least some of the pictures corresponding to different time instances in the video sequence, wherein said decoder determines whether pictures corresponding to a particular one of the different time instances are lost using an existing syntax element, the existing syntax element for performing another function other than picture loss determination.

26. The apparatus of claim 25, wherein the existing syntax element is a multi-view video coding syntax element.

27. The apparatus of claim 26, wherein the multi-view video coding syntax element corresponds to an extension of the International Organization for Standardization/International Electrotechnical Commission Moving Picture Experts Group-4 Part 10 Advanced Video Coding standard/International Telecommunication Union, Telecommunication Sector H.264 recommendation.

28. The apparatus of claim 25, wherein the existing syntax element is present at a high level.

29. The apparatus of claim 25, wherein the high level corresponds to at least at one of a slice header level, a sequence parameter set level, a picture parameter set level, a view parameter set level, a network abstraction layer unit header level, and a level corresponding to a supplemental enhancement information message.

30. The apparatus of claim 25, wherein the other function of the existing syntax element is for indicating a temporal level.

31. The apparatus of claim 30, wherein the pictures corresponding to the particular one of the different time instances include anchor pictures and non-anchor pictures, and said decoder ascertains whether anchor pictures corresponding to the particular one of the different time instances are lost using the temporal level, wherein the temporal level used is a first temporal level.

32. The apparatus of claim 31, wherein said decoder uses a drop in the temporal level from a highest temporal level in the bitstream to a non-zero temporal level, the drop being at least two or more integer values, to detect the loss of anchor pictures with the first temporal level equal to zero and corresponding to the particular one of the different time instances.

33. The apparatus of claim 31, wherein said decoder determines whether non-anchor pictures belonging to a missing temporal level and corresponding to the particular one of the different time instances are lost, based on an absence of the missing temporal level.

34. A method, comprising:
decoding pictures for at least one view corresponding to multi-view video content from a bitstream, the pictures representative of at least a portion of a video sequence, at least some of the pictures corresponding to different time instances in the video sequence, wherein said decoding step comprises determining whether pictures corresponding to a particular one of the different time instances are lost using an existing syntax element, the existing syntax element for performing another function other than picture loss determination.

35. The method of claim 34, wherein the existing syntax element is a multi-view video coding syntax element.

36. The method of claim 35, wherein the multi-view video coding syntax element corresponds to an extension of the International Organization for Standardization/International Electrotechnical Commission Moving Picture Experts Group-4 Part 10 Advanced Video Coding standard/International Telecommunication Union, Telecommunication Sector H.264 recommendation.

37. The method of claim 34, wherein the existing syntax element is present at a high level.

38. The method of claim 34, wherein the high level corresponds to at least at one of a slice header level, a sequence parameter set level, a picture parameter set level, a view parameter set level, a network abstraction layer unit header level, and a level corresponding to a supplemental enhancement information message.

39. The method of claim 34, wherein the other function of the existing syntax element is for indicating a temporal level.

40. The method of claim 39, wherein the pictures corresponding to the particular one of the different time instances include anchor pictures and non-anchor pictures, and said determining step comprises ascertaining whether anchor pictures corresponding to the particular one of the different time instances are lost using the temporal level, wherein the temporal level used is a first temporal level.

41. The method of claim 40, wherein said ascertaining step comprises detecting the loss of anchor pictures with the first temporal level equal to zero and corresponding to the particular one of the different time instances, using a drop in the temporal level from a highest temporal level in the bitstream to a non-zero temporal level, the drop being at least two or more integer values.

42. The method of claim 31, wherein said decoding step further comprises determining whether non-anchor pictures belonging to a missing temporal level and corresponding to the particular one of the different time instances are lost, based on an absence of the missing temporal level.
